(19) United States
(12) Patent Application Publication
(10) Pub. No.: US 2016/0314363 A1
(43) Pub. Date: Oct. 27, 2016

(54) OBSTACLE DETECTION APPARATUS AND METHOD

(71) Applicant: ELECTRONICS AND TELECOMMUNICATIONS RESEARCH INSTITUTE, Daejeon (KR)

(72) Inventor: Yun Won CHOI, Gyeongsan (KR)

(21) Appl. No.: 15/059,651

(22) Filed: Mar. 3, 2016

(30) Foreign Application Priority Data
Apr. 24, 2015 (KR) 10-2015-0058235

(51) Int. Cl. G06K 9/00; G06T 7/20; G06K 9/62; G06T 7/00

(52) U.S. Cl. CPC G06K 9/00805; G06T 7/0081; G06T 7/2006; G06T 7/204; G06K 9/6215; G06K 9/6202; G06K 9/627; G06T 2207/10024; G06T 2207/20148; G06T 2207/30261; G06T 2207/30241

(57) ABSTRACT

Provided are an obstacle detection apparatus and method using a difference image. The obstacle detection apparatus includes an difference image calculator configured to calculate a difference image from a target image from which an obstacle is to be recognized and a comparison image captured prior to the target image, an obstacle area extractor configured to extract an obstacle area which is predicted as including the obstacle, based on boundary information of the calculated difference image, an obstacle area information calculator configured to analyze image information of the extracted obstacle area to calculate a moving speed and moving direction of the obstacle and calculate a position of the obstacle from a reference positon of a camera, and a dangerous obstacle determiner configured to evaluate a danger grade of the obstacle, based on at least one of the moving speed, moving direction, and position of the obstacle.

### CROSS-REFERENCE TO RELATED APPLICATIONS

This application claims priority under 35 U.S.C. §119 to Korean Patent Application No. 10-2015-0058235, filed on Apr. 24, 2015, the disclosure of which is incorporated herein by reference in its entirety.

### TECHNICAL FIELD

The present invention relates to an obstacle detection apparatus and method, and more particularly, to an obstacle detection apparatus and method using a difference image, which detect an obstacle by using a difference image of two images which are captured by a camera at a certain time interval.

### BACKGROUND

Recently, interest in safety is increasing due to an accident caused by an obstacle (for example, a car, a motorcycle, a bicycle, or the like) approaching a periphery of a vehicle or a school bus while children or students are getting into and out of the vehicle or the school bus. A safety system such as wide-angle outside rearview mirrors attached to vehicles has a limitation in securing safety of passengers, and thus, it is required to develop technology for securing safety of passengers by using outer sensors of a vehicle.

In the related art for sensing obstacles around a vehicle, there is a method where an ultrasonic sensor is additionally attached to a vehicle to sense obstacles. The method has low reliability, a low sensing speed, and a number of recognition errors.

In comparison with an obstacle detection apparatus using a conventional ultrasonic sensor, a system using a camera may sense obstacles located in a wide area by using a single camera and thus has high reliability.

Examples of a method where a camera processes an obtained image to sense an object include a method using motion estimation based on an optical flow, a method using a difference between frames, and a method using learning of a database.

A motion sensing method using an optical flow is a method that analyzes successive images to allocate a speed vector and senses a feature point having a similar speed vector to extract a speed vector. Examples of the motion sensing method include a method, which traces an object by matching candidate areas based on area information, and a method that measures and extracts an optical flow on the assumption that a vector is slowly changed.

In addition, there are a method that separates a background area and a action area by using a contrast difference between adjacent images in a fixed camera and a method that merges a difference image and an edge image to extract action information of an object.

In a method using learning, a database that stores sufficient information about an object to recognize is needed, and a recognition rate varies depending on a result of learning. Also, the method using learning is slower in processing speed than other algorithms, and for this reason, is not suitable for real-time processing.

### SUMMARY

Accordingly, the present invention provides an obstacle detection apparatus and method, which obtain a difference image of two images which are captured by a camera at a certain time interval, extract an obstacle area from the obtained difference image, analyze an image of the obstacle area to calculate a direction and speed of an obstacle, and detect a dangerous obstacle by using the calculated direction and speed of the obstacle.

In one general aspect, an obstacle detection apparatus includes: an difference image calculator configured to calculate a difference image from a target image from which an obstacle is to be recognized and a comparison image captured prior to the target image; an obstacle area extractor configured to extract an obstacle area which is predicted as including the obstacle, based on boundary information of the calculated difference image; an obstacle area information calculator configured to analyze image information of the extracted obstacle area to calculate a moving speed and moving direction of the obstacle and calculate a position of the obstacle from a reference positon of a camera; and a dangerous obstacle determiner configured to evaluate a danger grade of the obstacle, based on at least one of the moving speed, moving direction, and position of the obstacle.

The difference image calculator may calculate a brightness value difference of pixels corresponding to the same position in the target image and the comparison image and may compare an absolute value of the brightness value difference with a predetermined threshold value to generate a binary image, binarized based on the predetermined threshold value, from a grayscale image corresponding to each of the target image and the comparison image.

The difference image calculator may connect a set of pixels where the absolute value of the brightness value difference is greater than the predetermined threshold value, thereby calculating boundary information.

While moving a virtual window with respect to the calculated difference image, the obstacle area extractor may summate binary values of pixels corresponding to an internal region of the virtual window and may extract, as an obstacle area, a virtual window area where a sum of the binary values of the pixels corresponding to the internal region of the virtual window is the maximum.

The obstacle area information calculator may calculate the moving direction of the obstacle as a direction where a brightness value difference of pixels corresponding to a boundary area calculated from the obstacle area has a positive (+) value.

The obstacle area information calculator may calculate the moving speed of the obstacle by using a moving distance of the obstacle and number of frames per second of the camera, which are calculated by scaling a width of a boundary area, calculated from the obstacle area, at a predetermined rate.

The dangerous obstacle determiner may classify the danger grade of the obstacle as a dangerous obstacle, an obstacle of interest, or an uninterested obstacle, based on whether the obstacle is located at a predetermined threshold distance, the moving speed of the obstacle, and the moving direction of the obstacle.

The dangerous obstacle determiner may classify, as the dangerous obstacle, an obstacle which is located at the predetermined threshold distance and moves in a reference position direction of the camera or an obstacle which is located out of the predetermined threshold distance and moves at a predetermined threshold speed or more in the reference position direction of the camera, may classify, as the obstacle of interest, an obstacle which is located at the predetermined threshold distance and does not move in the reference position direction of the camera or moves at less than the predetermined threshold speed in the reference position direction of the camera, and may classify other obstacles as uninterested obstacles.

In another general aspect, an obstacle detection method includes: calculating a difference image from a target image from which an obstacle is to be recognized and a comparison image captured prior to the target image; extracting an obstacle area which is predicted as including the obstacle, based on boundary information of the calculated difference image; analyzing image information of the extracted obstacle area to calculate a moving speed and moving direction of the obstacle and calculate a position of the obstacle from a reference positon of a camera; and evaluating a danger grade of the obstacle, based on at least one of the moving speed, moving direction, and position of the obstacle.

The calculating of the difference image may include: calculating a brightness value difference of pixels corresponding to the same position in the target image and the comparison image; comparing an absolute value of the brightness value difference with a predetermined threshold value to generate a binary image, binarized based on the predetermined threshold value, from a grayscale image corresponding to each of the target image and the comparison image; and connecting a set of pixels, where the absolute value of the brightness value difference is greater than the predetermined threshold value, to calculate boundary information.

The extracting of the obstacle area may include: while moving a virtual window with respect to the calculated difference image, summating binary values of pixels corresponding to an internal region of the virtual window; and extracting, as an obstacle area, a virtual window area where a sum of the binary values of the pixels corresponding to the internal region of the virtual window is the maximum.

The calculating of the moving direction may include calculating the moving direction of the obstacle as a direction where a brightness value difference of pixels corresponding to a boundary area calculated from the obstacle area has a positive (+) value.

The calculating of the moving speed may include calculating the moving speed of the obstacle by using a moving distance of the obstacle and number of frames per second of the camera, which are calculated by scaling a width of a boundary area, calculated from the obstacle area, at a predetermined rate.

The evaluating of the danger grade may include classifying the danger grade of the obstacle as a dangerous obstacle, an obstacle of interest, or an uninterested obstacle, based on whether the obstacle is located at a predetermined threshold distance, the moving speed of the obstacle, and the moving direction of the obstacle.

The evaluating of the danger grade may include: classifying, as the dangerous obstacle, an obstacle which is located at the predetermined threshold distance and moves in a reference position direction of the camera or an obstacle which is located out of the predetermined threshold distance and moves at a predetermined threshold speed or more in the reference position direction of the camera; classifying, as the obstacle of interest, an obstacle which is located at the predetermined threshold distance and does not move in the reference position direction of the camera or moves at less than the predetermined threshold speed in the reference position direction of the camera; and classifying other obstacles as uninterested obstacles.

Other features and aspects will be apparent from the following detailed description, the drawings, and the claims.

### BRIEF DESCRIPTION OF THE DRAWINGS

FIG. 1 is a block diagram illustrating a configuration of an obstacle detection apparatus according to an embodiment of the present invention.

FIGS. 2A to 2C are exemplary diagrams illustrating an operation of calculating obstacle information from a difference image, according to an embodiment of the present invention.

FIGS. 3A and 3B is a flowchart illustrating an obstacle detection method according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

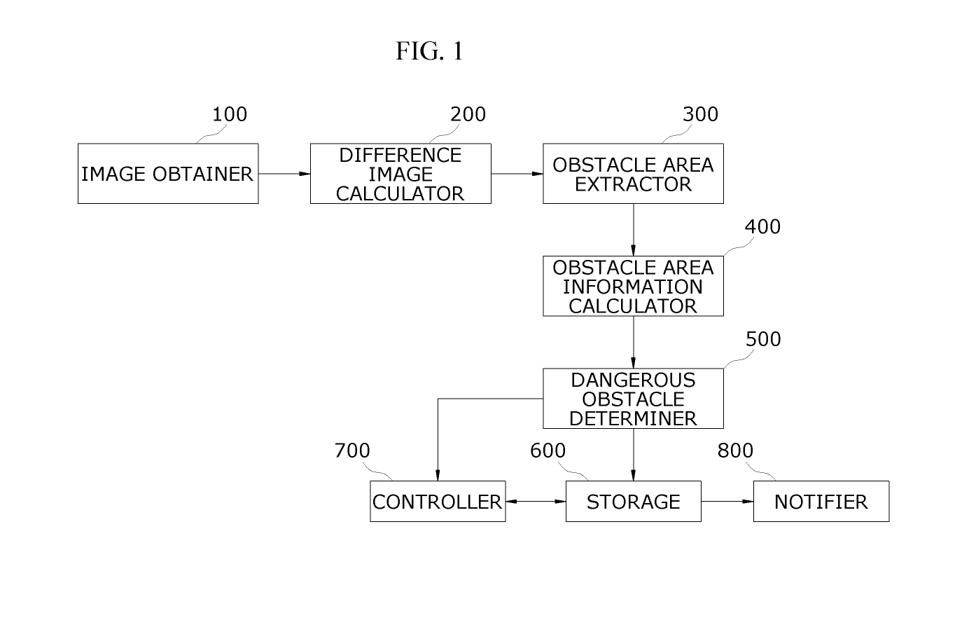

FIG. 1 is a block diagram illustrating a configuration of an obstacle detection apparatus according to an embodiment of the present invention.

Referring to FIG. 1, the obstacle detection apparatus according to an embodiment of the present invention may include an image obtainer 100, a difference image calculator 200, an obstacle area extractor 300, an obstacle area information calculator 400, a dangerous obstacle determiner 500, a controller 600, a storage 700, and a notifier 800.

The image obtainer 100 may convert an analog image signal, obtained from a camera, into a digital image signal having a predetermined frame per second and a predetermined resolution and may supply the digital image signal to the difference image calculator 200.

The difference image calculator 200 may calculate a difference image from a target image from which an obstacle is to be detected and a comparison image captured prior to the target image. That is, the difference image calculator 200 may subtract an image, captured at a time “t-1” immediately previous to a specific time “t”, from an image corresponding to the specific time “t” at which an obstacle is to be recognized, thereby calculating a difference image of two the images which are generated according to a movement of the obstacle.

Here, the difference image may denote a brightness value difference of pixels corresponding to the same position in the target image and the comparison image. This may denote that a binary image binarized based on an arbitrary threshold value is generated from two grayscale images.

For example, when a brightness value of a pixel corresponding to a specific position of the target image is Iₜ(x,y) and a brightness value of a pixel corresponding to a specific position of the comparison image is Iₜ₋₁(x,y), a brightness value difference of pixels corresponding to the same position may be Iₜ(x,y)−Iₜ₋₁(x,y).

The difference image calculator 200 may compare an absolute value “| Iₜ(x,y)−Iₜ₋₁(x,y) |” of the brightness value difference with a predetermined threshold value “Th”. As a result of the comparison, the difference image calculator 200 may generate a bindarized difference image through a process that allocates a value “1” to a pixel having an absolute value of a brightness value difference greater than the threshold value, and allocates a value “0” to a pixel having an absolute value of a brightness value difference which is not greater than the threshold value. Therefore, pixels where the absolute value of the brightness value difference is greater than the threshold value may be distinguished from pixels where the absolute value of the brightness value difference is not greater than the threshold value, and the difference image calculator 200 may connect a set of the pixels where the absolute value of the brightness value difference is greater than the threshold value, thereby calculating boundary information.

The obstacle area extractor 300 may extract an obstacle area which is predicted as including an obstacle, based on boundary information of the difference image calculated by the difference image calculator 200. Here, extracting the obstacle area may denote determining a minimum tetragon including an obstacle.

As an example of extracting the obstacle area, the obstacle area extractor 300 may use a method of calculating a sum of binary values of pixels. In a detailed embodiment, the obstacle area extractor 300 may perform a window tracing operation which arranges a left lower vertex of a virtual window at an original point of the difference image calculated by the difference image calculator 200 and calculates an image sum by summating all binary values of pixels in a virtual window area corresponding to each position of the virtual window while moving the virtual window at certain intervals. The virtual window may be moved by a certain interval along an x-coordinate direction in the difference image, and when the virtual window reaches a right end of the difference image, the virtual window may be moved by a certain interval along a y-coordinate direction.

When a window tracing operation is completed for a whole region of the difference image, a position having a maximum value may be determined by comparing a width of a corresponding virtual window with an image sum at each position to which a virtual window is moved, and a virtual window corresponding to the position having the maximum value may be extracted as an obstacle area.

The obstacle area information calculator 400 may analyze image information of the obstacle area extracted by the obstacle area extractor 300 to calculate a moving speed and moving direction of an obstacle and may calculate a position of the obstacle from a reference positon of the camera. Hereinafter, a moving speed, moving direction, and position of an obstacle may be defined as obstacle information.

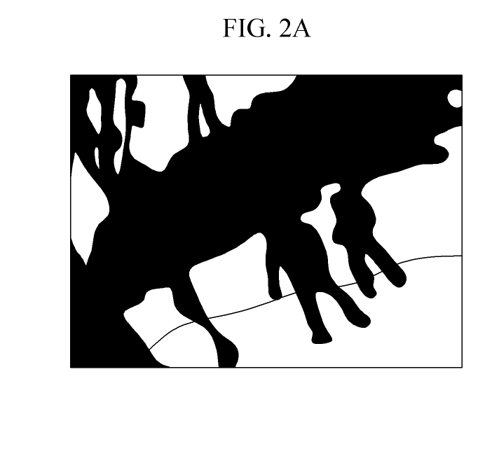

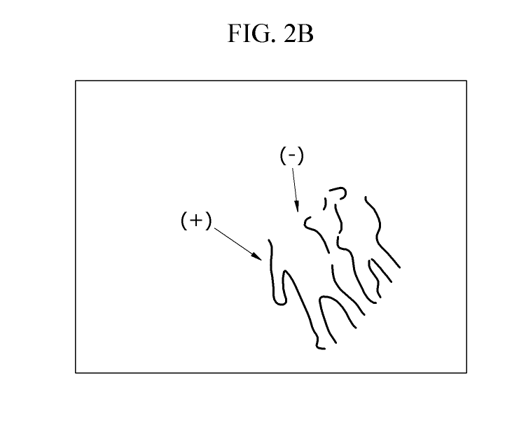

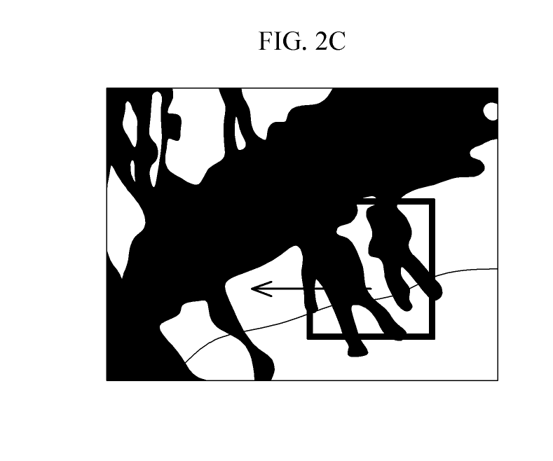

FIGS. 2A to 2C are exemplary diagrams illustrating an operation of calculating obstacle information from a difference image, according to an embodiment of the present invention. An image illustrated in FIG. 2A is an original image, an image illustrated in FIG. 2B is a difference image, and an image illustrated in FIG. 2C is a result image where obstacle information is calculated from the difference image.

As illustrated in FIGS. 2A to 2C, boundary information (for example, a boundary area) of an obstacle may be calculated from a difference image. In FIGS. 2A to 2C, the calculated boundary area of the obstacle may be illustrated as a white line or a gray line. Here, a boundary (or a boundary area) in a moving direction of the obstacle is illustrated as a white line, and a pixel corresponding to the boundary area may have a positive (+) value as a brightness value difference of the pixel. On the other hand, a boundary (or a boundary area) in a direction opposite to the moving direction of the obstacle is illustrated as a gray line, and a pixel corresponding to the boundary area may have a negative (−) value as a brightness value difference of pixels.

That is, the obstacle area information calculator 400 may calculate a moving direction of the obstacle as a direction where a brightness value difference of pixels corresponding to a boundary area calculated from the obstacle area has a positive (+) value.

Moreover, the obstacle area information calculator 400 may calculate a moving speed of the obstacle by using a moving distance of the obstacle and the number of frames per second of a camera, which are calculated by scaling a width of the boundary area, calculated from the obstacle area, at a predetermined rate.

For example, when it is assumed that the width of the boundary area calculated from the obstacle area is 2 mm, the moving distance of the obstacle which is calculated by scaling the width of the boundary area at a predetermined rate is 1 m, and the number of frames per second of the camera is 20 fps, the moving speed of the obstacle may be calculated as 20 m/s which is a result obtained by dividing the moving distance “1 m” by a moving time “ 1/20”.

The dangerous obstacle determiner 500 may classify a danger grade of an obstacle, based on whether the obstacle is located at a predetermined threshold distance, a moving speed of the obstacle, and a moving direction of the obstacle. Here, the danger grade may be classified into a dangerous obstacle, an obstacle of interest, and an uninterested obstacle.

For example, the dangerous obstacle determiner 500 may classify, as a dangerous obstacle, an obstacle which is located at the threshold distance and moves in a reference position direction of the camera or an obstacle which is located out of the threshold distance and moves at a predetermined threshold speed or more in the reference position direction of the camera.

Moreover, the dangerous obstacle determiner 500 may classify, as an obstacle of interest, an obstacle which is located at the threshold distance and does not move in the reference position direction of the camera or moves at less than the threshold speed in the reference position direction of the camera, and may classify other obstacles as uninterested obstacles.

The controller 600 may overall control the above-described elements according to an embodiment of the present invention. When it is determined by the dangerous obstacle determiner 500 that there is a dangerous obstacle, the controller 600 may supply a notification control signal, indicating the presence of the dangerous obstacle, to the notifier 800.

The notifier 800 may notify a user of the presence of the dangerous obstacle by using a voice, an image, and/or the like according to the notification control signal supplied from the controller 600.

The storage 700 may store obstacle information, which includes a moving speed, moving direction, and position of an obstacle calculated by the obstacle area information calculator 400, and information about each of a dangerous obstacle and an obstacle of interest which are determined by the dangerous obstacle determiner 500.

Hereinafter, an obstacle detection method according to an embodiment of the present invention will be described. Details repetitive of the description of the operation of the obstacle detection apparatus according to an embodiment of the present invention described above with reference to FIGS. 1 and 2 are omitted.

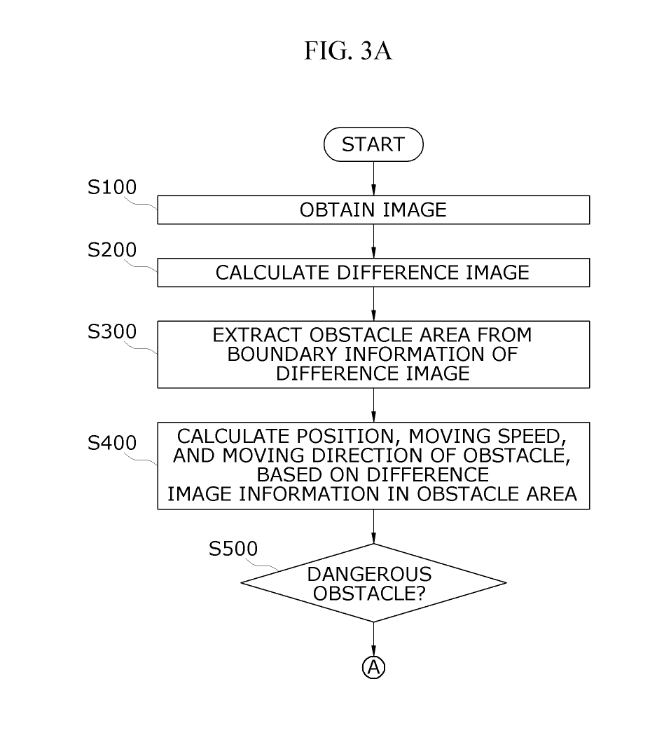

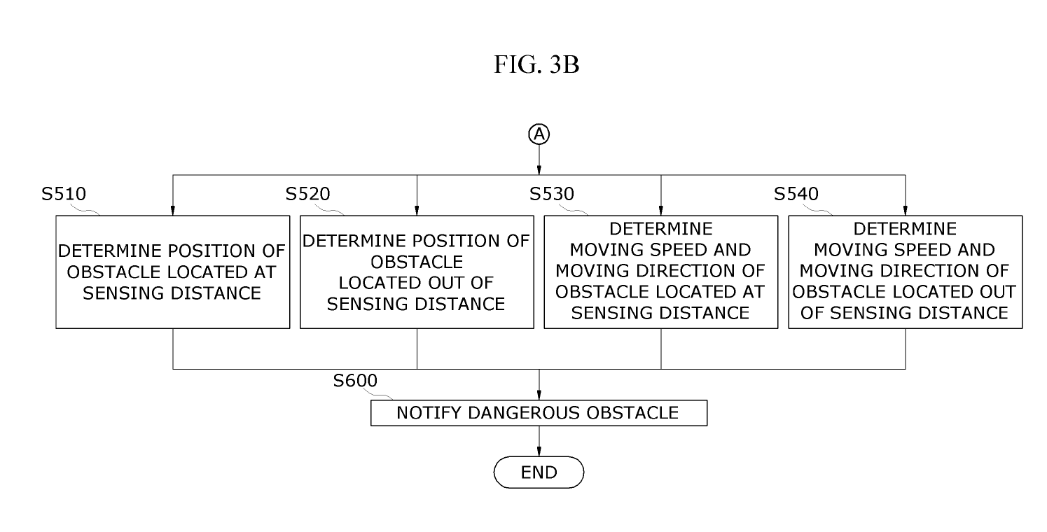

FIG. 3 and FIG. 3B is a flowchart illustrating an obstacle detection method according to an embodiment of the present invention.

Referring to FIGS. 1 and 3, in step S100, the image obtainer 100 may convert an analog image signal, obtained from a camera, into a digital image signal having a predetermined frame per second and a predetermined resolution and may output the digital image signal.

Subsequently, in step 200, the difference image calculator 200 may calculate a difference image from a target image from which an obstacle is to be detected and a comparison image captured prior to the target image. That is, the difference image calculator 200 may subtract an image, captured at a time “t-1” immediately previous to a specific time “t”, from an image corresponding to the specific time “t” at which an obstacle is to be recognized, thereby calculating a difference image of two the images which are generated according to a movement of the obstacle.

In the difference image, pixels where the absolute value of the brightness value difference is greater than the threshold value may be distinguished from pixels where the absolute value of the brightness value difference is not greater than the threshold value, and the difference image calculator 200 may connect a set of the pixels where the absolute value of the brightness value difference is greater than the threshold value, thereby calculating boundary information.

Subsequently, in step 300, the obstacle area extractor 300 may extract an obstacle area which is predicted as including an obstacle, based on boundary information of the calculated difference image.

In step S400, the obstacle area information calculator 400 may analyze image information of the obstacle area extracted by the obstacle area extractor 300 to calculate a moving speed and moving direction of the obstacle and may calculate a position of the obstacle from a reference positon of the camera.

Subsequently, in step S500, the dangerous obstacle determiner 500 may classify a danger grade of the obstacle, based on whether the obstacle is located at a predetermined threshold distance, a moving speed of the obstacle, and a moving direction of the obstacle.

For example, the dangerous obstacle determiner 500 may determine whether a position of the obstacle is within a predetermined threshold distance in step S510, whether the position of the obstacle is out of the threshold distance in step S520, what value a moving speed and moving direction of the obstacle have when the obstacle is located at the threshold distance in step S530, and what value the moving speed and moving direction of the obstacle have when the obstacle is located out of the threshold distance in step S540, thereby classifying a dangerous grade of the obstacle as a dangerous obstacle, an obstacle of interest, or an uninterested obstacle.

Subsequently, when it is determined by the dangerous obstacle determiner 500 that there is a dangerous obstacle, the controller 600 may supply information about the dangerous obstacle to the notifier 800 to allow the notifier 800 to notify a user of the presence of the dangerous obstacle by using a voice, an image, and/or the like in step S600.

According to the embodiments of the present invention, an obstacle area having a possibility that there is an obstacle may be previously calculated by using a difference image of two images which are captured by a camera at a certain time interval, and obstacle information including a positon, moving direction, and moving speed of an obstacle may be calculated by analyzing an image of the obstacle area. Accordingly, stable sensing performance and tracing performance against a dangerous obstacle are secured at a high processing speed in comparison with the related art.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An obstacle detection apparatus comprising:
difference image calculator configured to calculate a difference image from a target image from which an obstacle is to be recognized and a comparison image captured prior to the target image;
an obstacle area extractor configured to extract an obstacle area which is predicted as including the obstacle, based on boundary information of the calculated difference image;
an obstacle area information calculator configured to analyze image information of the extracted obstacle area to calculate a moving speed and moving direction of the obstacle and calculate a position of the obstacle from a reference positon of a camera; and
a dangerous obstacle determiner configured to evaluate a danger grade of the obstacle, based on at least one of the moving speed, moving direction, and position of the obstacle.

2. The obstacle detection apparatus of claim 1, wherein the difference image calculator calculates a brightness value difference of pixels corresponding to the same position in the target image and the comparison image and compares an absolute value of the brightness value difference with a predetermined threshold value to generate a binary image, binarized based on the predetermined threshold value, from a grayscale image corresponding to each of the target image and the comparison image.

3. The obstacle detection apparatus of claim 2, wherein the difference image calculator connects a set of pixels where the absolute value of the brightness value difference is greater than the predetermined threshold value, thereby calculating boundary information.

4. The obstacle detection apparatus of claim 1, wherein while moving a virtual window with respect to the calculated difference image, the obstacle area extractor summates binary values of pixels corresponding to an internal region of the virtual window and extracts, as an obstacle area, a virtual window area where a sum of the binary values of the pixels corresponding to the internal region of the virtual window is the maximum.

5. The obstacle detection apparatus of claim 1, wherein the obstacle area information calculator calculates the moving direction of the obstacle as a direction where a brightness value difference of pixels corresponding to a boundary area calculated from the obstacle area has a positive (+) value.

6. The obstacle detection apparatus of claim 1, wherein the obstacle area information calculator calculates the moving speed of the obstacle by using a moving distance of the obstacle and number of frames per second of the camera, which are calculated by scaling a width of a boundary area, calculated from the obstacle area, at a predetermined rate.

7. The obstacle detection apparatus of claim 1, wherein the dangerous obstacle determiner classifies the danger grade of the obstacle as a dangerous obstacle, an obstacle of interest, or an uninterested obstacle, based on whether the obstacle is located at a predetermined threshold distance, the moving speed of the obstacle, and the moving direction of the obstacle.

8. The obstacle detection apparatus of claim 7, wherein
the dangerous obstacle determiner classifies, as the dangerous obstacle, an obstacle which is located at the predetermined threshold distance and moves in a reference position direction of the camera or an obstacle which is located out of the predetermined threshold distance and moves at a predetermined threshold speed or more in the reference position direction of the camera,
the dangerous obstacle determiner classifies, as the obstacle of interest, an obstacle which is located at the predetermined threshold distance and does not move in the reference position direction of the camera or moves at less than the predetermined threshold speed in the reference position direction of the camera, and
the dangerous obstacle determiner classifies other obstacles as uninterested obstacles.

9. An obstacle detection method comprising:
calculating a difference image from a target image from which an obstacle is to be recognized and a comparison image captured prior to the target image;
extracting an obstacle area which is predicted as including the obstacle, based on boundary information of the calculated difference image;
analyzing image information of the extracted obstacle area to calculate a moving speed and moving direction of the obstacle and calculate a position of the obstacle from a reference positon of a camera; and
evaluating a danger grade of the obstacle, based on at least one of the moving speed, moving direction, and position of the obstacle.

10. The obstacle detection method of claim 9, wherein the calculating of the difference image comprises:
calculating a brightness value difference of pixels corresponding to the same position in the target image and the comparison image;
comparing an absolute value of the brightness value difference with a predetermined threshold value to generate a binary image, binarized based on the predetermined threshold value, from a grayscale image corresponding to each of the target image and the comparison image; and
connecting a set of pixels, where the absolute value of the brightness value difference is greater than the predetermined threshold value, to calculate boundary information.

11. The obstacle detection method of claim 9, wherein the extracting of the obstacle area comprises:
while moving a virtual window with respect to the calculated difference image, summating binary values of pixels corresponding to an internal region of the virtual window; and
extracting, as an obstacle area, a virtual window area where a sum of the binary values of the pixels corresponding to the internal region of the virtual window is the maximum.

12. The obstacle detection method of claim 9, wherein the calculating of the moving direction comprises calculating the moving direction of the obstacle as a direction where a brightness value difference of pixels corresponding to a boundary area calculated from the obstacle area has a positive (+) value.

13. The obstacle detection method of claim 9, wherein the calculating of the moving speed comprises calculating the moving speed of the obstacle by using a moving distance of the obstacle and number of frames per second of the camera, which are calculated by scaling a width of a boundary area, calculated from the obstacle area, at a predetermined rate.

14. The obstacle detection method of claim 9, wherein the evaluating of the danger grade comprises classifying the danger grade of the obstacle as a dangerous obstacle, an obstacle of interest, or an uninterested obstacle, based on whether the obstacle is located at a predetermined threshold distance, the moving speed of the obstacle, and the moving direction of the obstacle.

15. The obstacle detection method of claim 14, wherein the evaluating of the danger grade comprises:
classifying, as the dangerous obstacle, an obstacle which is located at the predetermined threshold distance and moves in a reference position direction of the camera or an obstacle which is located out of the predetermined threshold distance and moves at a predetermined threshold speed or more in the reference position direction of the camera;
classifying, as the obstacle of interest, an obstacle which is located at the predetermined threshold distance and does not move in the reference position direction of the camera or moves at less than the predetermined threshold speed in the reference position direction of the camera; and
classifying other obstacles as uninterested obstacles.
